(19) United States
(12) Patent Application Publication
(10) Pub. No.: US 2026/0238642 A1
(43) Pub. Date: Aug. 13, 2026

(54) INTER-GOVERNMENTAL WATCHLIST USING BLOCKCHAIN

(71) Applicant: SECURIPORT LLC, Reston, VA (US)

(72) Inventors: Felipe SEGURA, Reston, VA (US); Enrique SEGURA, Reston, VA (US)

(21) Appl. No.: 19/534,417

(22) Filed: Feb. 9, 2026

Related U.S. Application Data
(60) Provisional application No. 63/755,310, filed on Feb. 7, 2025.

(51) Int. Cl. H04L 9/40

(52) U.S. Cl. CPC H04L 63/0861

(57) ABSTRACT

Systems, devices, methods, and instructions for secure intergovernmental sharing and matching of biometric templates, including a permissioned blockchain configured to store biometric templates securely and provide access control, allowing participation and access by authorized entities based on predefined permissions, an encryption module configured to encrypt biometric templates using zero-knowledge proof techniques prior to storage on the blockchain, a hashing module configured to generate hashed representations of encrypted biometric templates for matching purposes, and a decentralized communication mechanism to enable intergovernmental communication about potential matches without revealing match details to unauthorized entities.

### PRIORITY INFORMATION

This application claims the benefit of U.S. Provisional Patent Application No. 63/755,310, field on February 7, 2025, which is hereby incorporated by reference in its entirety.

### FIELD

The present disclosure relates to the field of secure intergovernmental communication systems, and more particularly to employing blockchain technology for the sharing and matching of one or more biometric templates.

### BACKGROUND

The field of this disclosure pertains to information technology systems used in intergovernmental communication and data sharing, particularly on the secure exchange and verification of biometric information. Biometric data, such as facial images and fingerprints, have become increasingly important in global security operations due to their enhanced ability to identify individuals accurately. However, the management of this information across borders poses additional and significant challenges, given the need to balance the security of sensitive data with the operational need for sharing such information among trusted governmental entities.

Existing technologies in this domain have predominantly relied on centralized systems for storing and matching biometric data. These centralized systems often require a trusted third party to manage data access and integrity, which introduces several potential vulnerabilities. The concentrated nature of data storage makes these systems attractive targets for cyberattacks, potentially compromising sensitive biometric information. Additionally, sharing sensitive data across governments often involves cumbersome legal and procedural complexities, exacerbating the issues of interoperability and timely access to crucial information.

In addressing the shortcomings of the prior art, current approaches fail to provide a satisfactory balance between data sharing and privacy protection in biometric systems. The exposure of biometric templates during sharing or matching processes can lead to significant privacy concerns, as unauthorized access to these templates poses risks of identity theft and other privacy violations. Furthermore, existing solutions often lack sufficient mechanisms to prevent unauthorized data exchange, resulting in limited control over who has access to sensitive information.

### SUMMARY

Accordingly, the embodiments of the present invention are directed to inter-government watchlist using blockchain that substantially obviate one or more problems due to limitations and disadvantages of the related art.

One object of the technology is to enhance data security and privacy in the context of intergovernmental cooperation by employing zero-knowledge proof encryption techniques. This encryption method enables the storage of biometric templates on the blockchain without exposing sensitive biometric data, ensuring that only verifiable identities are shared.

Another object of the technology is to facilitate decentralized intergovernmental communication about potential matches. The decentralized communication mechanism enables sharing information about potential matches in a secure manner, ensuring that match details are only disclosed to entities with appropriate permissions as defined by the participating countries.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The embodiments provide systems, devices, methods and instructions for secure sharing and matching of biometric templates, including a permissioned blockchain configured to store biometric templates securely and provide access control, allowing participation and access by authorized entities based on predefined permissions, an encryption module configured to encrypt biometric templates using zero-knowledge proof techniques prior to storage on the blockchain, a hashing module configured to generate hashed representations of encrypted biometric templates for matching purposes, and a decentralized communication mechanism to enable inter-entity communication about potential matches without revealing match details to unauthorized entities.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 shows a schematic representation of a multi-country biometric verification system comprising a distributed blockchain network that enables secure intergovernmental sharing of encrypted biometric templates.

FIG. 2 illustrates a detailed network interaction among the countries described in FIG. 1, showing the cryptographic processing pipeline and blockchain interfaces that enable secure biometric template sharing.

FIG. 3 illustrates a method for securely sharing and matching biometric templates across multiple governmental entities using a distributed blockchain watchlist.

FIG. 4 illustrates a flowchart outlining the process for securely sharing biometric templates across a distributed blockchain network using zero-knowledge proof cryptography and permissioned access controls.

### DETAILED DESCRIPTION

Reference will now be made in detail to the embodiments of the present invention, examples of which are illustrated in the accompanying drawings. Wherever possible, like reference numbers will be used for like elements.

The present disclosure relates to secure intergovernmental communication systems, and to employing blockchain technology for the sharing and matching of biometric templates. It utilizes the integration of permissioned blockchain infrastructure, zero-knowledge proof encryption, and hashing techniques to enhance privacy and security in the cross-border exchange of biometric data, for example.

In the discussion that follows, biometric templates are discussed. A biometric template is generally a mathematical representation of a person’s unique biological or behavioral characteristics that has been extracted from raw biometric data and processed into a standardized digital format for storage, comparison, and identification purposes. Some non-limiting examples will now be provided.

In various embodiments, the biometric templates stored on the permissioned blockchain may comprise one or more of numerous biometric modalities beyond facial images, iris scans, and fingerprints. Physical or physiological biometric templates may include palm print templates that capture ridge patterns and principal lines from the palm surface, palm vein templates that analyze vascular patterns beneath the skin using near-infrared imaging, finger vein templates, hand geometry templates that measure the length, width, and thickness of fingers and palm, retinal scan templates that map blood vessel patterns on the retina, iris templates that encode unique patterns in the colored portion of the eye, DNA profiles based on genetic markers, ear shape templates that analyze acoustic geometry, and dental record templates. Behavioral biometric templates may include voice recognition templates that capture vocal characteristics such as pitch, tone, and cadence, gait analysis templates that characterize walking patterns including stride length and hip rotation, etc. Emerging biometric modalities may include electrocardiogram (ECG) templates representing unique heart rhythm patterns, electroencephalogram (EEG) templates capturing brainwave patterns, skin texture or pore analysis templates, nail bed pattern templates, lip movement pattern templates, and gaze pattern templates that track eye movement characteristics. The system may implement multi-modal biometric authentication by combining two or more biometric templates, such as facial recognition combined with voice recognition, fingerprint combined with iris scanning, or palm print combined with finger vein patterns, to achieve higher matching accuracy and enhanced security. Each biometric template, regardless of modality, is processed through the encryption module to generate zero-knowledge proof commitments prior to storage on the blockchain, thereby ensuring that the underlying biometric data remains confidential while enabling secure cross-border biometric verification among participating governmental entities.

The embodiments provide computer-enabled systems, devices, methods, and instructions that enable secure, decentralized sharing of biometric information between government entities, while effectively maintaining data privacy and integrity. Implementation of the embodiments eliminates reliance on centralized trusted third parties, providing a robust framework to control access and permissions among participating countries. The embodiments ensure that intergovernmental cooperation and communication can occur without placing sensitive biometric data at risk, addressing ongoing security and privacy concerns associated with cross-border data exchange.

The embodiments provide systems, devices, methods, and instructions for the secure intergovernmental sharing and matching of biometric templates, utilizing a permissioned blockchain to ensure that only authorized entities have access to the stored biometric data. The blockchain is configured to uphold access control based on predefined permissions set by participating countries, thereby regulating participation in the data-sharing process.

In an example embodiment, the system includes an encryption module configured to encrypt both facial images and fingerprints prior to their storage on the blockchain. The hashed representations of these encrypted templates are then generated for matching purposes, ensuring that secure comparisons can be performed without revealing the actual biometric templates.

In another example embodiment, the system is further configured to enable each participating country to independently add and retrieve encrypted biometric templates via the blockchain. This aspect of the technology ensures that countries have autonomous control over their data input and retrieval processes, thereby supporting independent data management.

In another example embodiment, secure sharing and matching of biometric templates are performed by storing encrypted biometric templates and utilizing hashing techniques to ensure secure comparisons. The embodiments further include enabling intergovernmental communication regarding potential biometric matches while preserving data privacy through restricted communication mechanisms based on established permissions.

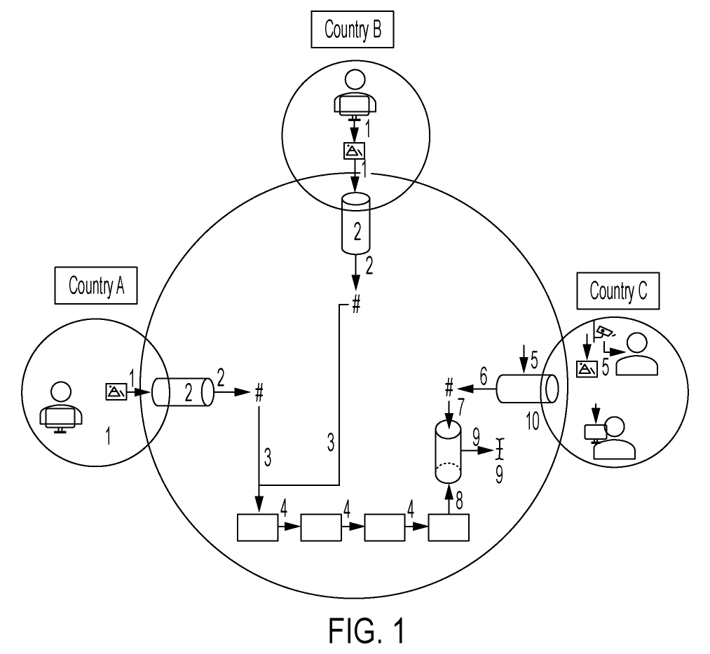

FIG. 1 shows a schematic representation of a multi-country biometric verification system comprising a distributed blockchain network that enables secure intergovernmental sharing of encrypted biometric templates.

As shown, FIG. 1 includes Country A, Country B, and Country C, each depicted within separate circles representing autonomous governmental entities operating independent blockchain nodes. In Country A, a user is interacting with a computing device, and the captured biometric data is transmitted and processed through element 1, which comprises an encryption module configured to generate zero-knowledge proof commitments from the biometric templates. Element 2 represents a centralized database where data from Country B is managed. For example, element 2 represents a distributed blockchain ledger where encrypted biometric commitments from Country B and other participating countries are stored and accessible according to predefined access control permissions, eliminating reliance on a centralized trusted third party. Country B also utilizes a computing system where data is transferred from element 1 comprising a biometric capture and encryption module to element 2 comprising a blockchain interface for writing encrypted templates to the permissioned blockchain. In Country C, element 5 denotes a data processing unit that receives and processes biometric data captured from images recorded via element 6, such as facial images obtained at border control checkpoints. Element 10 in Country C connects this data processing to further verification systems including the blockchain query interface that generates zero-knowledge proofs for matching queries against the distributed watchlist. Elements 3, 4, 7, 8, and 9 represent various processing and communication stages within this decentralized network, including hashing modules, cryptographic proof generators, smart contract execution nodes, and secure communication channels facilitating cross-border data exchanges essential for biometric verification while maintaining data privacy through encryption and zero-knowledge proof techniques.

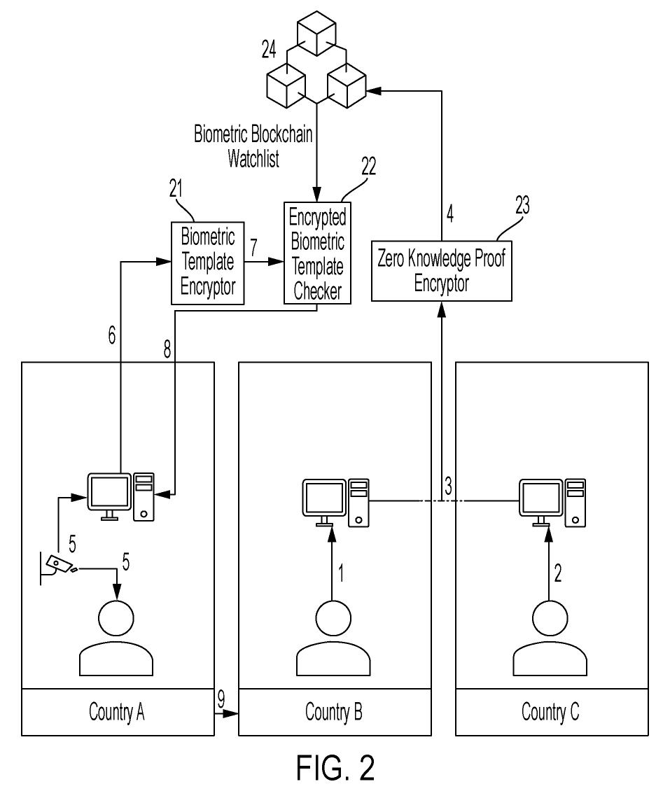

FIG. 2 illustrates a detailed network interaction among the countries described in FIG. 1, showing the cryptographic processing pipeline and blockchain interfaces that enable secure biometric template sharing. Country A, Country B, and Country C are shown as separate sections, each with respective computing infrastructure depicted by element 6 for Country A, comprising a biometric capture device and local processing server, element 1 for Country B, comprising a blockchain node with smart contract execution capability, and element 2 for Country C, comprising a validator node configured to verify zero-knowledge proofs and execute matching queries. Smart contract execution capability refers to the ability of a blockchain node or network to run self-executing computer programs (e.g., smart contracts) that automatically enforce predetermined rules and execute transactions when specific conditions are met, without requiring human intervention or a trusted intermediary. The biometric data captured via element 5, which may include facial images, fingerprints, or other biometric modalities, is encrypted by the Biometric Template Encrypter 21, which implements zero-knowledge proof algorithms such as zk-SNARKs or Pedersen commitment schemes to generate cryptographic commitments from the biometric feature, which are transmitted at element 7 to Encrypted Biometric Template Checker 22. This data is verified through an Encrypted Biometric Template Checker 22 that validates the mathematical correctness and format compliance of the encrypted templates before interacting with a Biometric Blockchain Watchlist 24, which comprises the distributed ledger storing encrypted biometric commitments along with associated metadata and access control permissions defined by the contributing countries. The system employs a Zero Knowledge Proof Encrypter 23 which generates cryptographic proofs demonstrating template validity and match results without revealing the underlying biometric data, thereby ensuring complete data privacy before information exchange across the countries by enabling verification of biometric matches without exposing actual biometric templates to the blockchain network or unauthorized participating entities.

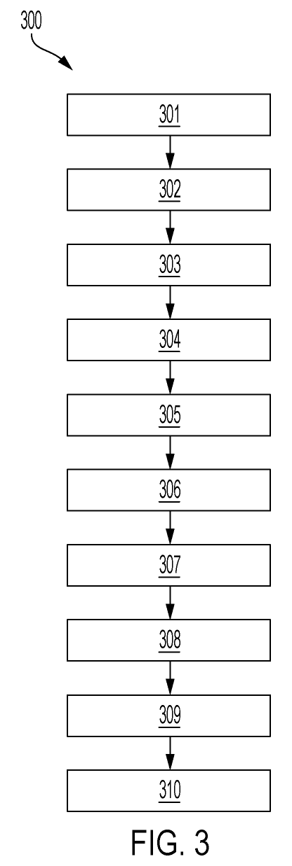

Turning to FIG. 3, a flowchart of the biometric data management and verification process is provided. Country A and Country B collaborate to upload biometric templates of subjects of interest to a shared database between Countries A, B, and C. These actions involve hashing and encrypting the images and any textual data. The process maintains a distributed watchlist updated iteratively, allowing countries to manage entries securely. Country C verifies incoming passengers using these entries, implementing similar encryption methods as used by Countries A and B to ensure consistency and privacy.

FIG. 3 illustrates a method for securely sharing and matching biometric templates across multiple governmental entities using a distributed blockchain watchlist.

At the outset, at 301, the method 300 includes enrolling encrypted biometric templates onto the permissioned blockchain, wherein Countries A and B decide to upload the biometric templates of Subjects of Interest (SOI) along with any relevant information about the SOI, and a custom protocol of what country can match and view information about the SOI to a shared database with Countries A, B, and C. Here, the method 300 includes receiving biometric data from Country A or Country B at an encryption module, generating a cryptographic commitment from the biometric template using zero-knowledge proof encryption techniques, and storing the encrypted commitment on the distributed blockchain ledger along with access control permissions specifying which participating countries are authorized to match against and view information about the enrolled SOI.

At 302, the method 300 includes implementing privacy-preserving data sharing controls, wherein since Countries A and B do not wish to share their SOI's information with all of the participating countries in the database unless their SOI's matches with a passenger entering one of the member countries borders. Countries A and B proceed to use a hashing mechanism that is part of the distributed database to convert the biometric template image and any textual information on the person that Country A or B would like a country that matches with an encrypted SOI to know about is hashed. Here, the method 300 further comprises processing the biometric template through a hashing module to generate a hashed representation, encrypting metadata associated with the SOI using the hashing mechanism, configuring smart contract logic to restrict access to the encrypted SOI information based on match results and predefined inter-governmental permissions, and storing (e.g., only) the hashed biometric representation and encrypted metadata on the blockchain while retaining the original biometric template in the enrolling country's local secure database.

At 303, the method 300 includes storing encrypted templates and maintaines data integrity, wherein once the image is hashed, and the text is encrypted, the original image is deleted and the hash and its encrypted text are automatically uploaded onto the distributed watchlist. Here, the method 300 comprises executing a blockchain transaction that writes the cryptographic hash and encrypted metadata to the distributed ledger, validating the transaction through consensus among authorized blockchain validator nodes, deleting the original unencrypted biometric image from temporary storage, and recording an immutable timestamp and transaction identifier on the blockchain to create an auditable record of the enrollment.

At 304, the method 300 includes implementing version control and entry management, wherein the watchlist is constantly being refreshed and with each new iteration salts the previous iterations of the watchlist as to ensure that no member country can attempt to reverse engineer previous entries onto the watchlist and enable the member countries to delete previous entries whenever they wish. Here, the method 300 comprises generating a new cryptographic salt value for each blockchain block or time period, applying the salt to hash functions used in subsequent enrollments to prevent correlation attacks across different versions of the watchlist, maintaining a versioned ledger structure that allows participating countries to issue deletion requests for their previously enrolled entries, processing deletion requests through smart contract logic that verifies the requesting country's authorization, and updating the blockchain state to mark deleted entries as inactive while preserving the immutable audit trail of the deletion event. "Salting" includes adding a unique, random string of characters (the "salt") to an input, typically before it is hashed.

At 305, the method 300 includes initiating biometric verification query, wherein over in Country C, person 1 enters the Country, and the Immigration Authority initiates a check of person 1 so as to ensure that person 1 is not an SOI on the distributed watchlist. Here, the method 300 comprises capturing biometric data from person 1 at a border control checkpoint operated by Country C, extracting a biometric feature template from the captured data using the same template extraction algorithm employed by the enrolling countries, and transmitting the extracted template to Country C's blockchain interface module for matching processing. The country C takes a photo of the person entering the country and sends the image of person 1 through the verification feature of the distributed watchlist.

At 306, the method 300 includes generating zero-knowledge proof for secure matching. Using the same or similar method of encryption for the entry of SOI's used in step 302, the watchlist check first encrypts the image of person 1 into a hash along with the signature of the node of Country C. Here, the method 300 comprises processing person 1's biometric template through the encryption module to generate a cryptographic hash; digitally signing the hash with Country C's private cryptographic key to authenticate the query origin, generating a zero-knowledge proof that demonstrates "a template matching person 1's biometric data would produce a similarity score above the matching threshold with at least one enrolled template on the blockchain" without revealing person 1's actual biometric data. This function is available to each node of the distributed watchlist and is therefore not recorded on the records of the watchlist so as to ensure that none of the other participating members can see what, when, and how often country C is checking against the watchlist. Here, the method 300 further comprises submitting the zero-knowledge proof along with the encrypted hash to the blockchain's smart contract for verification.

At 307, the method 300 includes executing off-database hash comparison, wherein once hashed, the encrypted hash runs into another black box function off-database, to check the hash of person 1 against the hashes of SOI's on the watchlist. Here, the method 300 comprises retrieving the submitted zero-knowledge proof and encrypted hash from the blockchain, executing a smart contract function that verifies the mathematical validity of the zero-knowledge proof without accessing the underlying biometric templates, performing cryptographic hash comparisons between the query hash and enrolled SOI hashes stored on the distributed ledger, and determining match candidates based on hash proximity or equality while maintaining zero-knowledge properties throughout the comparison process.

At 308, the method 300 includes retrieving and validating potential matches, wherein once initiated, the function pulls all of the valid condensed hashes within the latest version of the distributed database so as to verify whether the hash of person 1 matches any the hashes on the database. Here, the method 300 comprises querying the blockchain to retrieve all active (e.g., non-deleted) encrypted biometric hashes from the current version of the watchlist, filtering the retrieved hashes based on Country C's access permissions as defined in the smart contract access control lists, computing similarity metrics between person 1's hash and each authorized SOI hash, identifying matches where the similarity metric exceeds a predefined threshold value, and generating a match result set comprising the cryptographic identifiers of matching SOI entries along with confidence scores.

At 309, the method 300 includes processing match results and determining notification protocol, wherein in this scenario, the passenger's information returns a match with a SOI hash posted from Country B on the ledger. Here, the method 300 comprises detecting that person 1's biometric hash matches an SOI entry enrolled by Country B, retrieving the encrypted metadata and access control permissions associated with the matched SOI entry from the blockchain, evaluating the smart contract logic to determine whether Country C is authorized to view detailed information about the matched SOI based on the permissions set by Country B during enrollment. Since all of these matches are off-database, Country A or B have no knowledge of the match or verification, thereby preserving the privacy of Country C's query operations. Since Country C has a good relationship with country B, Country B has enabled their encrypted SOI's to match and release information with any match that contains the signature of the Node of Country C, and the method 300 further comprises determining that Country C has the requisite permissions to receive match notification.

Lastly, at 310, the method 300 includes transmitting match information to authorized authorities, wherein all of the decrypted information and the information of the match with the SOI is sent to the relevant authorities of Country C which decides whether they will notify Country B about their recent match or not offline. Here, the method comprises decrypting the matched SOI metadata using Country C's private cryptographic key; transmitting the decrypted SOI information along with person 1's biometric data and the match confidence score to designated immigration authorities within Country C through a secure communication channel, enabling the Country C authorities to review the match information and make a determination regarding further action, optionally generating an off-blockchain notification to Country B informing them that their enrolled SOI has been matched at Country C's border, wherein the notification includes the timestamp, location, and match identifier but does not reveal person 1's actual biometric data or identity unless Country C chooses to share such information through separate diplomatic or law enforcement channels, and recording the match event and any subsequent notifications in an immutable audit log on the blockchain for accountabity and compliance purposes.

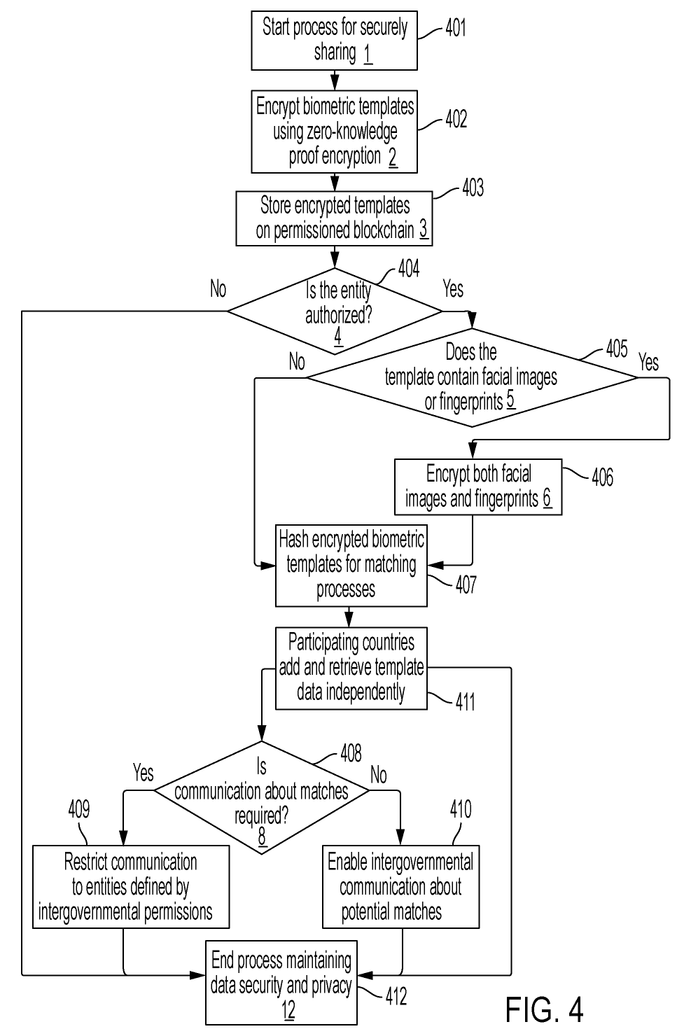

FIG. 4 depicts a flowchart outlining the process for securely sharing biometric templates across a distributed blockchain network using zero-knowledge proof cryptography and permissioned access controls.

At step 401, the process begins, focusing on secure data sharing wherein a participating country initiates enrollment of a subject of interest onto the intergovernmental watchlist. Step 402 includes encrypting biometric templates using zero-knowledge proof encryption, wherein an encryption module receives biometric data and generates cryptographic commitments such as zk-SNARK proofs or Pedersen commitments that mathematically represent the biometric template without revealing the actual biometric features. The templates in the form of encrypted cryptographic commitments are then stored on a permissioned blockchain at step 403, wherein a blockchain transaction writes the encrypted commitment to the distributed ledger and validator nodes achieve consensus to validate and record the transaction. The system checks if an entity is authorized at step 404, wherein smart contract logic evaluates the requesting entity's cryptographic credentials against access control lists (ACLs) stored on the blockchain to verify that the entity possesses the requisite permissions to access or query the watchlist. If authorized, step 405 assesses whether the template includes facial images or fingerprints or other biometric modalities; if so, step 406 encrypts the data, wherein the biometric features are processed through cryptographic algorithms to generate feature-specific encrypted representations that preserve biometric matching capability while preventing unauthorized reconstruction of the original biometric data. Step 407 hashes encrypted biometric templates for matching, wherein a hashing module applies cryptographic hash functions to the encrypted templates to generate fixed-length hash values that enable efficient comparison operations during matching queries while maintaining zero-knowledge properties. Participating countries add and retrieve this template data independently at step 411, wherein each country's blockchain node interface enables autonomous writing of new encrypted entries and querying of existing entries according to the permissions granted by the contributing countries, thereby eliminating dependence on centralized intermediaries. If communication about matches is needed, step 408 routes the process to step 409, which restricts communication to only those countries that have been granted explicit permission by the enrolling country to receive match notifications as defined in the smart contract access control logic, or to step 410, which enables intergovernmental communication by decrypting match metadata and transmitting detailed SOI information to authorized countries through secure channels while generating immutable audit records of the disclosure event on the blockchain. The process concludes at step 412, emphasizing data security and privacy through the combination of zero-knowledge proof encryption, permissioned blockchain access controls, cryptographic authentication, and selective information disclosure mechanisms that enable cross-border biometric verification while preventing unauthorized access to sensitive biometric templates.

In the embodiments, various inputs and/or combinations of inputs may be received by the encryption module and processed for enrollment onto the permissioned blockchain or for query matching against the distributed watchlist, including: biometric images captured from subjects of interest or individuals being screened, (e.g., facial photographs, two-dimensional or three-dimensional facial scans, fingerprints, fingerprint impressions from one or more fingers, palm prints, palm vein images captured through near-infrared imaging, iris scans, retinal scans, or other physiological or behavioral biometrics), mathematical representations of the biometric image generated through feature extraction and template generation algorithms (e.g., cryptographic hash values, biometric feature representations), parts or sub-parts of an image including segmented regions of interest extracted from larger biometric captures (e.g., cropped facial regions isolating eyes, nose, and mouth; individual fingerprint ridge patterns; specific iris quadrants), information extracted from an image through optical character recognition (OCR), pattern recognition, or computer vision algorithms (e.g., a passport number extracted or pulled from a photograph of a passport, visa information extracted from travel document images, birth dates parsed from identification cards, or text fields extracted from scanned forms), information extracted from a near field communication (NFC) chip embedded in machine-readable travel documents (MRTDs) or electronic identification cards (e.g., passport numbers that are stored in the NFC chip of the passport, biographical data fields, digital photographs stored in contactless chips, fingerprint templates stored on e-passports compliant with ICAO standards, or cryptographic certificates used for document authentication), key value pairs of data whether in a string or binary format, or numerical representations of unique identifiers (e.g., a passport number represented as an alphanumeric string, a national identification number, a visa control number, a criminal record identifier, a biometric reference number linking to external law enforcement databases, or GPS coordinates indicating location of SOI sighting), and contextual metadata associated with the subject of interest including known aliases, threat level classifications, associated criminal activities, country of origin, last known location, and any special handling instructions defined by the enrolling governmental entity. The system is configured to accept these diverse input types either individually or in combination, process them through the encryption module to generate zero-knowledge proof commitments, and store the resulting encrypted representations on the blockchain while maintaining the privacy and security of the underlying sensitive data.

In the embodiments, various outputs are generated by the system and returned to querying countries through the blockchain's smart contract execution capability, including: binary match indicators such as Boolean values (e.g., the system executes a smart contract function that evaluates zero-knowledge proofs and cryptographic hash comparisons to determine, using the distributed watchlist, whether there is a match with the inputted biometric template). The system responds with a "yes" or "no" Boolean value indicating match or no-match status without revealing the underlying biometric data or the specific watchlist entry that triggered the match; quantitative match metrics comprising the number of potential matches with a confidence score for each match, wherein there can be more than one match and a confidence score ranging from 0.0 to 1.0 (or 0% to 100%) that is calculated and associated with each potential match identified on the watchlist, with each confidence score representing the degree of similarity between the query biometric template and the enrolled template as computed through cryptographic comparison functions executed by the smart contract; and comprehensive match result packages comprising multiple data elements including: a string message providing human-readable alert information, a numerical confidence score indicating match certainty, a Boolean value confirming match status, the cryptographic wallet address or number identifying the enrolling country that submitted the matched watchlist entry, an encrypted biometric image commitment (not the plaintext image), optionally a partial image or image segment if authorized by the enrolling country's permission settings, near-field communication (NFC) data such as passport numbers extracted from NFC-enabled travel documents, and all metadata and contextual information associated with the enrolled subject of interest (SOI) that the inputted query matched against, wherein after matching with an input, the smart contract returns: the wallet number or cryptographic address of the country that enrolled the matched SOI entry is displayed to the querying country, there is a Boolean value indicating whether there was a match or not, the confidence score of that match expressed as a numerical probability or percentage, the encrypted image commitment which may include tagged metadata or a string value that serves as an action message instructing the querying country on recommended actions (e.g., "detain for questioning," "refer to secondary inspection," "notify Interpol"), and optionally the complete set of encrypted metadata fields associated with the matched SOI entry including aliases, known associates, risk level classification, and warrant status, all transmitted through secure blockchain channels and decrypted only by authorized countries possessing the requisite cryptographic keys as defined in the smart contract access control lists.

In one example embodiment, the encryption module utilizes zero-knowledge succinct non-interactive arguments of knowledge (zk-SNARKs) to enable biometric template matching without revealing the actual biometric data. When Country A enrolls a person of interest onto the watchlist, the system first extracts a biometric template comprising a multi-dimensional feature vector (e.g., a 512-dimensional vector representing facial landmarks, inter-ocular distances, and geometric ratios). Rather than storing this template directly on the blockchain, the encryption module generates a cryptographic commitment C by computing a hash function over the concatenation of the biometric template T and a random nonce value r, such that C = Hash(T || r). The system then generates a zk-SNARK proof π that mathematically demonstrates "I know a biometric template T and nonce r such that Hash(T || r) equals commitment C, and T conforms to valid biometric template format requirements." Only the commitment C and proof π are recorded on the permissioned blockchain, while Country A retains the actual template T and nonce r in their local secure database. This approach ensures that the blockchain nodes and other participating countries can verify the validity of the watchlist entry without gaining access to the underlying biometric information.

When Country C subsequently needs to verify an incoming passenger against the distributed watchlist, the zero-knowledge proof mechanism enables secure matching while preserving privacy for both the watchlist entries and the query. Country C captures biometric data from the passenger and extracts a query template T'. The system then generates a zero-knowledge proof π' that demonstrates: "I possess a template T' that, when compared to at least one committed template on the blockchain using a similarity function (such as cosine similarity or Euclidean distance), produces a matching score exceeding the predefined threshold θ." This proof is constructed using a cryptographic circuit that takes as public inputs the blockchain commitments and similarity threshold, and as private inputs the query template T' and the enrolled template T retrieved through secure computation. The circuit verifies that Hash(T || r) equals a stored commitment C and that the similarity metric Sim(T, T') ≥ θ, outputting a binary result. Critically, the blockchain's smart contract can verify proof π' and confirm a match exists without learning the actual biometric template of either the watchlist subject or the queried passenger. Upon successful verification, the smart contract returns only the encrypted metadata associated with the matched entry, such as the originating country's cryptographic wallet address and alert classification level, thereby enabling intergovernmental notification while maintaining zero-knowledge properties throughout the matching process.

In another example embodiment, the system employs Pedersen commitments combined with zero-knowledge range proofs to achieve similar privacy-preserving matching capabilities with enhanced efficiency for large-scale biometric databases. Each biometric template is represented as a vector of N numerical features [f₁, f₂, ..., fₙ], and for each feature fᵢ, the encryption module generates a Pedersen commitment Cᵢ = g^fᵢ · h^rᵢ, where g and h are generator points on an elliptic curve and rᵢ is a random blinding factor known only to the enrolling country. The vector of commitments [C₁, C₂, ..., Cₙ] is stored on the blockchain while the actual feature values and blinding factors remain with the originating country. When performing a match query, Country C generates a zero-knowledge range proof (e.g., a Bulletproof) demonstrating that the sum of squared differences between their query template features and a committed template's features falls below a specified threshold: Σᵢ(fᵢ - f'ᵢ)² < Δ. This range proof can be efficiently verified by the blockchain validators without revealing any individual feature values, difference calculations, or the exact similarity score, thereby proving a biometric match exists while maintaining complete confidentiality of the biometric data itself. The homomorphic properties of Pedersen commitments enable computation on committed values, allowing the system to perform distance calculations in the encrypted domain and return only a Boolean match indicator along with the associated encrypted watchlist metadata to the querying country.

In yet another example embodiment, the permissioned blockchain is implemented using Hyperledger Fabric, a modular blockchain framework that provides enterprise-grade permissions management and confidentiality features particularly suited for intergovernmental data sharing. The Hyperledger Fabric network comprises multiple peer nodes, each operated by a participating country or authorized governmental entity, along with ordering service nodes that manage transaction sequencing and block creation. Each participating country operates at least one peer node configured with a digital certificate issued by a certificate authority (CA) that establishes the country's identity and access permissions within the network. The blockchain utilizes channels - private sub-networks within the main blockchain - to enable selective data sharing, such that Country A and Country B might share certain watchlist entries on Channel 1, while Country A and Country C share different entries on Channel 2, thereby implementing granular access control at the blockchain protocol level. Smart contracts, referred to as "chaincode" in Hyperledger Fabric, are deployed on these channels to enforce business logic governing biometric template storage, matching requests, and result disclosure. The chaincode validates that only authorized entities can write encrypted biometric commitments to the ledger, verifies zero-knowledge proofs submitted during match queries, and controls which countries receive notification when a match is detected based on predefined permission policies stored within the chaincode logic. The endorsement policy mechanism in Hyperledger Fabric requires that a specified number of peer nodes (e.g., three out of five participating countries) must validate and endorse each transaction before it is committed to the blockchain, providing Byzantine fault tolerance and ensuring that no single country can unilaterally manipulate watchlist entries or matching results.

In the various embodiments, the system can employ a private Ethereum network utilizing a Proof of Authority (PoA) consensus mechanism, wherein designated validator nodes operated by trusted governmental entities are authorized to create new blocks and validate transactions. Unlike public Ethereum networks that use Proof of Work or Proof of Stake, the PoA consensus is suitable for permissioned intergovernmental systems because it provides fast block finality (typically 5-15 seconds per block), deterministic validator selection, and elimination of cryptocurrency mining requirements. Each participating country operates one or more validator nodes running Ethereum client software (e.g., Geth or OpenEthereum) configured with the private network's genesis block and a pre-approved list of validator addresses. Smart contracts written in Solidity programming language can be deployed to the private Ethereum blockchain to implement the biometric watchlist functionality, including contracts for storing encrypted biometric commitments, verifying zero-knowledge proofs, managing access control through cryptographic wallet addresses, and emitting events that trigger intergovernmental notifications when matches are detected. The Ethereum Virtual Machine (EVM) can execute these smart contracts in a deterministic manner across all validator nodes, ensuring that all participating countries maintain an identical copy of the watchlist state and that matching logic produces consistent results regardless of which node processes a query. The private Ethereum network can implement additional privacy features through integration with privacy-preserving protocols such as Aztec or zkSync, which enable confidential transactions where the transaction amounts (in this case, biometric matching scores or confidence levels) are encrypted using homomorphic encryption schemes while still allowing validators to verify transaction validity through zero-knowledge proofs, thereby adding an additional layer of privacy beyond the base blockchain protocol.

The permissioned access controls can be implemented through a multi-layered authorization framework that combines cryptographic identity verification, role-based access control (RBAC) policies encoded in smart contracts, and attribute-based access control (ABAC) mechanisms. Each participating country is provisioned with a unique cryptographic key pair, wherein the private key is securely maintained by the country's designated blockchain node operators and the corresponding public key is registered on the blockchain along with a digital certificate issued by a trusted certificate authority (CA) that attests to the country's identity and authorization level. When a country attempts to perform an action on the blockchain, such as adding a new encrypted biometric template, querying the watchlist, or retrieving match results, the transaction must be digitally signed using the country's private key, and the blockchain validators verify this signature against the registered public key to authenticate the requesting entity. Smart contracts deployed on the blockchain maintain access control lists (ACLs) that specify granular permissions for each registered country, defining which operations each country is authorized to perform (e.g., Country A may have "write" permissions to add watchlist entries and "read" permissions to query all entries, while Country D may only have "read" permissions limited to entries explicitly shared with it).

In some configurations, the smart contracts can further implement attribute-based policies that evaluate contextual factors during authorization decisions, such as verifying that a match query originates from a border control system (validated through the transaction's metadata and originating node attributes), confirming that the querying country has reciprocal data-sharing agreements with the countries that contributed the watchlist entries being queried, and checking that the time of the query falls within authorized operational hours specified in intergovernmental agreements. Additionally, the system implements capability-based access control wherein countries can issue time-limited, revocable cryptographic tokens (capabilities) to specific sub-entities within their jurisdiction (e.g., granting a particular airport immigration office temporary query permissions for a 24-hour period), with these capabilities being represented as signed tokens that are validated by the smart contract before granting access to restricted operations. The blockchain maintains an immutable audit log of all access attempts, successful operations, and authorization failures, recording the requesting entity's cryptographic identity, timestamp, operation type, and result, thereby providing complete transparency and accountability for all access to the biometric watchlist while enforcing strict controls over who can view, add, or match against sensitive biometric data.

Although not shown in the figures, the system may include a bus and/or other communication mechanism(s) configured to communicate information between the various components and participating countries of the system, such as one or more processors (e.g., a biometric template extraction processor, cryptographic video or biometric processing controller, zero-knowledge proof generation processor, or blockchain transaction processor) and one or more memory devices (e.g., encrypted biometric template storage, blockchain ledger storage, cryptographic key storage, or smart contract code repositories). In addition, a communication device may enable connectivity between a processor and other system components or blockchain nodes operated by different participating countries by encoding data to be sent from the processor to another component or remote node over a network and decoding data received from another node in the distributed blockchain system over the network for the processor. The communication device implements secure communication protocols including Transport Layer Security (TLS), encryption standards such as AES-256, and authenticated channels using digital certificates to ensure that biometric data, zero-knowledge proofs, and blockchain transactions are transmitted securely between governmental entities.

For example, the communication device may include a network interface card that is configured to provide wireless network communications between blockchain nodes, border control terminals, and central governmental servers. A variety of wireless communication techniques may be used including infrared, radio, Bluetooth, Wi-Fi, and/or cellular communications such as 4G LTE, 5G, or satellite communications for remote border locations. Alternatively, the communication device may be configured to provide wired network connection(s), such as an Ethernet connection, fiber optic connections for high-bandwidth blockchain synchronization, or dedicated secure government network connections (e.g., leased lines, virtual private networks) that ensure encrypted and authenticated data transmission between participating countries' blockchain infrastructure.

The processor may comprise one or more general or specific purpose processors (e.g., a graphic or video processor for biometric image processing, a cryptographic coprocessor or hardware security module (HSM) for executing encryption algorithms and managing cryptographic keys, an application-specific integrated circuit (ASIC) optimized for hash computations, or a graphics processing unit (GPU) configured for parallel processing of zero-knowledge proof generation) to perform computation and control functions of the system. The processor may include a single integrated circuit, such as a micro-processing device, or may include multiple integrated circuit devices and/or circuit boards working in cooperation to accomplish the functions of the processor. In some embodiments, the processor may include specialized cryptographic hardware accelerators that improve the performance of computationally intensive operations such as zk-SNARK proof generation, elliptic curve cryptography for digital signatures, and homomorphic encryption computations, thereby enabling real-time biometric matching and blockchain transaction processing even with large-scale watchlist databases containing millions of encrypted biometric templates.

The system may include one or more memory devices for storing information and instructions for execution by the various system components. The memory may contain various software and data components for retrieving, presenting, modifying, and storing data. For example, the memory may store software modules that provide functionality when executed by the processor. The software modules may include an operating system that provides operating system functionality for the system. The software modules may further include blockchain client software (e.g., Hyperledger Fabric peer node software, Ethereum Geth client), smart contract execution engines, cryptographic libraries implementing zero-knowledge proof protocols (e.g., libsnark, bellman, bulletproofs), artificial intelligence models for biometric feature extraction, self-learning algorithms that improve matching accuracy over time, and various biometric template extraction and video and biometric analytics modules configured to execute the functionality described in connection with FIGS. 1-4. Additional software modules may include access control policy enforcement modules, audit logging components that record all blockchain transactions and access attempts, key management services for securely storing and retrieving cryptographic keys, and API interfaces that enable integration with existing governmental border control systems and law enforcement databases.

The one or more memory devices may include a variety of computer-readable media that may be accessed by the processor. For example, the memory may include any combination of random-access memory ("RAM"), including DDR4 or DDR5 RAM for high-speed processing of biometric comparisons, dynamic RAM ("DRAM"), static RAM ("SRAM"), read only memory ("ROM"), including EEPROM or flash ROM for storing firmware and cryptographic boot sequences, flash memory, such as NAND flash or NVMe solid-state drives for blockchain ledger storage, cache memory, including L1, L2, and L3 processor cache for accelerating cryptographic operations, and/or any other type of non-transitory or transitory computer-readable medium. In certain embodiments, secure memory elements such as trusted platform modules (TPMs) or hardware security modules (HSMs) provide tamper-resistant storage for cryptographic keys, ensuring that private keys used for blockchain transactions and biometric template decryption cannot be extracted even if the physical hardware is compromised.

The one or more processors are further coupled via the bus to a display, such as a stationary display or touch screen interface that presents biometric matching results, watchlist management interfaces, blockchain transaction status, and administrative dashboards to authorized governmental personnel. A keyboard and a cursor control device, such as a computer mouse, trackpad, or touchscreen interface, are further coupled to the communication device to enable a user to interface with the system. Biometric input devices such as fingerprint scanners, facial recognition cameras, iris scanners, or palm vein readers may also be coupled to the system to capture biometric data from subjects of interest during enrollment or from individuals being screened during query operations at border control checkpoints.

One or more databases may store one or more biometric templates, encrypted biometric commitments, zero-knowledge proofs, blockchain transaction history, access control policies, and related applications. The databases may store data in an integrated collection of logically-related records or files. The databases may be implemented as an operational database, providing real-time access to current watchlist entries and match results, an analytical database for performing statistical analysis on matching patterns and cross-border security trends, a data warehouse consolidating historical biometric matching data from multiple participating countries for intelligence analysis, a distributed database wherein each participating country maintains a synchronized copy of the blockchain ledger, an end-user database providing interfaces for border control officers to query the watchlist, an external database interfacing with Interpol, FBI, or other international law enforcement databases, a navigational database, an in-memory database such as Redis or Memcached for caching frequently accessed biometric templates to accelerate matching operations, a document-oriented database such as MongoDB for storing flexible JSON-formatted metadata associated with watchlist entries, a real-time database providing immediate updates when new biometric templates are enrolled or matches are detected, a relational database such as PostgreSQL or MySQL for managing structured data including country permissions and audit logs, an object-oriented database, a graph database for analyzing relationships between subjects of interest and known associates, a time-series database for tracking the temporal evolution of watchlist entries and matching patterns, or any other database known in the art. In preferred embodiments, the blockchain itself serves as a distributed, immutable database wherein encrypted biometric commitments and transaction records are replicated across all participating countries' nodes, ensuring data persistence, fault tolerance, and tamper-evidence without reliance on a centralized database authority.

Accordingly, disclosure provides systems, devices, methods, and instructions for secure intergovernmental sharing and matching of biometric templates, including a permissioned blockchain configured to store biometric templates securely and provide access control, allowing participation and access by authorized entities based on predefined permissions, an encryption module configured to encrypt biometric templates using zero-knowledge proof techniques prior to storage on the blockchain, a hashing module configured to generate hashed representations of encrypted biometric templates for matching purposes, and a decentralized communication mechanism to enable intergovernmental communication about potential matches without revealing match details to unauthorized entities.

Although the intergovernmental use case has been described as an example, the embodiments are not so limited. In an alternative commercial embodiment, the system enables a consortium of retail establishments to collaboratively maintain a distributed watchlist for loss prevention and security purposes while maintaining granular control over which alert types trigger notifications at each participating location. For example, multiple retail stores may implement the permissioned blockchain system to share information about individuals who have engaged in prohibited conduct such as shoplifting, fraud, vandalism, or policy violations. Each participating store operates a blockchain node with smart contract execution capability and can enroll biometric templates of individuals along with tagged metadata indicating the nature of the offense (e.g., "shoplifting," "smoking indoors," "trespassing," "return fraud," "aggressive behavior"). The smart contract access control logic enables each store to configure customizable alert preference profiles that specify which offense categories should trigger notifications when a biometric match is detected. In an example scenario, Store A captures facial biometric data from an individual who violated their no-smoking policy by smoking inside the store premises. Store A's system generates an encrypted biometric commitment using zero-knowledge proof techniques, tags the entry with the offense classification "smoking indoors," and uploads this information to the shared blockchain watchlist. Store B, which participates in the same retail consortium and has access to query the distributed watchlist, has configured its alert preferences to only trigger notifications for theft-related offenses (shoplifting, fraud, burglary) and does not wish to exclude customers solely for smoking violations. When the same individual subsequently enters Store B and their facial biometric is captured by Store B's surveillance cameras, the system extracts a biometric template, generates a zero-knowledge proof, and queries the blockchain watchlist. The smart contract executes a matching function that cryptographically compares Store B's query against enrolled templates and detects a match with the entry previously uploaded by Store A. However, the smart contract's conditional logic evaluates Store B's alert preference configuration stored in the blockchain's access control policies, determines that Store B has not enabled alerts for the "smoking indoors" offense category, and consequently suppresses the notification. Store B's security personnel receive no alert about this individual, and the person proceeds through the store without intervention. Meanwhile, the blockchain maintains an immutable audit log recording that (1) Store A enrolled a biometric template with a "smoking indoors" tag, (2) Store B performed a query that resulted in a cryptographic match, and (3) no alert was generated due to Store B's preference settings, thereby providing complete transparency and accountability while respecting each store's autonomous decision-making regarding which offenses warrant exclusion from their premises. This embodiment demonstrates the system's flexibility in enabling collaborative information sharing among commercial entities while preserving each participant's ability to customize operational responses based on their individual risk tolerance, business policies, and customer service philosophy, all implemented through programmable smart contract logic executed on the distributed blockchain infrastructure.

It will be apparent to those skilled in the art that various modifications and variations can be made in the embodiments of the present invention without departing from the spirit or scope of the invention. Thus, it is intended that the present invention cover the modifications and variations of this invention provided they come within the scope of the appended claims and their equivalents.

1. A system for secure intergovernmental sharing and matching of biometric templates, comprising:
a permissioned blockchain configured to store biometric templates securely and provide access control, allowing participation and access by authorized entities based on predefined permissions;
an encryption module configured to encrypt biometric templates using zero-knowledge proof techniques prior to storage on the blockchain;
a hashing module configured to generate hashed representations of encrypted biometric templates for matching purposes; and
a decentralized communication mechanism to enable intergovernmental communication about potential matches without revealing match details to unauthorized entities.

2. The system of claim 1, wherein the blockchain is configured to allow each authorized entity to add and retrieve encrypted biometric templates independently.

3. The system of claim 1, wherein the encryption module is further configured to utilize facial images or fingerprints as biometric templates.

4. The system of claim 1, wherein the hashing module is configured to process both biometric templates stored on the blockchain and those submitted for query to ensure secure comparisons.

5. The system of claim 1, wherein the decentralized communication mechanism allows for restricted communication of match results based on permissions set by authorized entities.

6. A method for securely sharing and matching biometric templates using a blockchain, comprising:
storing biometric templates on a permissioned blockchain with access restricted to authorized entities;
encrypting biometric templates using zero-knowledge proof encryption prior to blockchain storage;
hashing encrypted biometric templates for matching processes; and
enabling intergovernmental communication about potential biometric matches while maintaining data security and privacy.

7. The method of claim 6, wherein the step of encrypting biometric templates includes encryption of both facial images and fingerprints.

8. The method of claim 6, further comprising restricting communication about matched data to specific entities as defined by intergovernmental permissions.

9. The method of claim 6, wherein the step of storing biometric templates involves each participating country independently adding and retrieving template data.

10. The method of claim 6, wherein the step of hashing encrypted biometric templates ensures that secure comparisons between stored biometric data and submitted queries are made without exposing the biometric information itself.

11. A system for secure sharing and matching of biometric templates, comprising:
a permissioned blockchain configured to store biometric templates securely and provide access control, allowing participation and access by authorized entities based on predefined permissions;
an encryption module configured to encrypt biometric templates using zero-knowledge proof techniques prior to storage on the blockchain;
a hashing module configured to generate hashed representations of encrypted biometric templates for matching purposes; and
a decentralized communication mechanism to enable inter-entity communication about potential matches without revealing match details to unauthorized entities.
